(19) United States
(12) Patent Application Publication
(10) Pub. No.: US 2009/0052970 A1
(43) Pub. Date: Feb. 26, 2009

(54) Device for extracting paste contents

(76) Inventor: Chung Hyun Jung, Kwangju (KR)

Correspondence Address: HARNESS, DICKEY & PIERCE, P.L.C., P.O. BOX 8910, RESTON, VA, 20195, US

(21) Appl. No.: 10/592,009

(22) PCT Filed: Mar. 9, 2005
(86) PCT No.: PCT/KR05/00658

§ 371 Date: Aug. 12, 2008

(30) Foreign Application Priority Data
Mar. 9, 2004 (KR) 10-2004-0015817

(51) Int. Cl. B43K 5/04; B65D 35/22; B67D 5/52; B67D 5/42

(52) U.S. Cl. 401/152; 222/94; 222/390; 222/391; 222/137

(57) ABSTRACT

Disclosed is a device for extracting paste contents. The device includes a storing unit for individually storing at least one paste content therein in order to extract the paste content to an exterior and a pushing unit for pushing the paste content stored in the storing unit. The pushing unit is detachably coupled with the storing unit. The storing unit is formed at an inner portion thereof with at least one storing cavity for individually storing the paste content. An exhaust port is formed at a front end of the storing cavity in order to exhaust the paste content and an injection port is formed at a rear end of the storing cavity for injecting the paste content into the storing cavity. Thus, paste contents, such as toothpaste, are easily extracted from the device. A connector is coupled to a paste content exhaust section of the device.

### TECHNICAL FIELD

The present invention relates to an extracting device, and more particularly to an extracting device capable of easily extracting paste materials, such as toothpaste.

Paste materials, such as toothpaste or ointment, may exist in a non-coagulant state. However, the phase of the paste materials may be shifted into a coagulant state if they are exposed to an exterior for a predetermined period of time.

In general, the paste materials are stored in soft tubes in such a manner that the paste materials can be extracted from the soft tubes when external force is applied to the soft tubes.

However, since it is difficult to completely compress the soft tubes, the paste materials may remain in the soft tubes when the soft tubes are discarded.

### BACKGROUND ART

In order to solve the above problem, applicant of the present invention has suggested a container for extracting paste contents, which has been filed with Korean Intellectual Patent Office on Oct. 23, 2002 and assigned serial No. 10-2002-64836.

As shown in FIG. 23, the container for extracting paste contents includes a housing 10, a piston 50, an actuator 20, a lower cap 90 and an upper cap 80.

The piston 50 is used for extracting paste contents A stored in the housing 10, so the piston 50 is installed in the housing 10 such that the piston 50 can move up and down within the housing 10. The piston 50 includes an inclined surface 52 and a protrusion 54.

The inclined surface 52 corresponds to an inclined surface 14 formed at an upper portion of the housing 10 and the protrusion 54 corresponds to a neck 15 of the housing 15 so that the piston 50 can move up to an upper end of the housing 10.

The actuator 20 is used for moving the piston 50. The actuator 20 is formed at an outer peripheral portion thereof with a first male screw-section 25 and formed at a lower inner peripheral portion thereof with a third female screw-section 23.

The actuator 20 is screw-coupled into the housing 10 until it makes contact with the piston 50 by means of the first male screw section 25 and a first female screw section 12.

When the actuator 20 makes contact with the piston 50, the user can extract a desired amount of the paste contents A by adjusting a screw-movement of the actuator 20.

However, the conventional container represents a problem in that the user must grip the housing with one hand and rotate the actuator with the other hand in order to extract the paste contents stored in the container. That is, the conventional container makes it difficult to extract the paste contents with only one hand.

### DISCLOSURE OF INVENTION

### Technical Problem

Therefore, the present invention has been made in view of the above-mentioned problems, and it is a first object of the present invention to provide a device for extracting paste contents allowing a user to easily extract the paste contents with only one hand.

A second object of the present invention is to provide a device for extracting paste contents allowing a user to simultaneously extract at least two kinds of paste contents with only one hand.

A third object of the present invention is to provide a device for extracting paste contents allowing a user to simultaneously extract at least two kinds of paste contents by mixing the paste contents with only one hand.

A fourth object of the present invention is to provide a device for extracting paste contents, which can be reused even if an old paste container is exchanged with a new paste container.

A fifth object of the present invention is to provide a device for extracting paste contents, which is adaptable for multipurpose use by coupling a connector to a paste exhaust section of the device.

### Technical Solution

In order to accomplish the above objects, according to one aspect of the present invention, there is provided a device for extracting paste contents, the device comprising: a means for individually storing at least one paste content therein in order to extract the paste content to an exterior; and a means for pushing the paste content stored in the storing means, the pushing means being detachably coupled with the storing means.

The storing means is formed at an inner portion thereof with at least one storing cavity for individually storing the paste content, a first exhaust port is formed at a first end of the storing cavity in order to exhaust the paste content, and a first injection port is formed at a second end of the storing cavity for injecting the paste content into the storing cavity.

The pushing means includes a pushing member fully making contact with an inner peripheral wall of the storing means having the storing cavity in order to seal the storing means.

### ADVANTAGEOUS EFFECTS

The device for extracting the paste contents according to the present invention includes a driving device installed in the second body in order to extract the paste contents stored in the first body, so the user may easily extract the paste contents with one hand.

In addition, the device for extracting the paste contents according to the present invention can store at least two kinds of paste contents in the first body or includes at least two paste content containers having the paste contents therein, so that different kinds of paste contents can be simultaneously exhausted.

Furthermore, the device for extracting the paste contents according to the present invention includes the first body provided with the cap having one exhaust port, so that at least two kinds of paste contents can be simultaneously exhausted while being mixed with each other.

In addition, according to the present invention, if the paste contents have been completely used, the paste contents can be directly filled in the storing cavity of the first body or the paste content container can be exchanged with a new one so that the device for extracting the paste contents according to the present invention can be semi-permanently used.

When the device for extracting the paste contents according to the present invention includes the paste content containers, the new paste contents are not mixed with old paste contents, so that various kinds of paste contents having various components and flavors can be utilized as required by the user.

In addition, if the paste content container is fabricated by using rigid materials such that it can be separated from the first body as described in the seventh embodiment of the present invention, the inner portion of the paste content container can be easily washed so that it is possible to fill the paste content container with new paste contents while preventing the new paste contents from being mixed with old paste contents. Accordingly, the device for extracting the paste contents of the present invention can be semi-permanently used by easily exchanging the old paste content container with a new paste content container in accordance with user s taste.

As described in the seventh embodiment, the device for extracting the paste contents according to the present invention further includes the push bra stopper tip, so that the backward movement of the push bar can be prevented when the user pushes the push button even if pressure of the paste contents stored in the paste content container increases because the cap is not opened.

In addition, since the first case is connected to the second case by means of the hinge and the coupling/decoupling unit is provided in opposition to the hinge for coupling or decoupling the first case to or from the second case with the push bar retrieving tip, the paste content container can be easily exchanged.

Furthermore, the connector can be coupled to the paste content exhaust section of the extracting device of the present invention, so that the extracting device of the present invention not only exhausts at least one kind of paste contents, but also can be used in various purposes by using the connector.

If the connector is provided in the form of the brush unit as described in the eighth embodiment of the present invention, at least one kind of hair-dyes can be uniformly exhausted through the brush unit, so that it is not necessary to perform hair-dye mixing work. In addition, the hair-dye can be applied to hair when the user combs the hair so that it is not necessary to directly apply the hair-dye to the head skin.

In addition, a plurality of exhaust tubes are formed lengthwise along the brush unit and the size of the exhaust tubes is gradually increased lengthwise along the body section of the brush unit in accordance with pressure of the paste contents exhausted from the exhaust port of the paste content container in such a manner that the exhaust paste contents can be uniformly exhausted to the exterior through the exhaust tubes. Accordingly, the user can uniformly apply the hair-dye to hair when the user combs the hair.

Furthermore, since the height of the exhaust tubes is lower than that of the brushes, the hair-dye is mainly applied to the hair of the user and the paste contents are prevented from directly making contact with the head skin of the user, so the head skin of the user can be prevented from being damaged.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic exploded perspective view illustrating a device for extracting paste contents according to a first embodiment of the present invention;

FIG. 2 is a sectional view illustrating an internal structure of a first body taken along line A-A of a device for extracting paste contents shown in FIG. 1;

FIG. 3 is a sectional view illustrating an internal structure of a second body taken along line B-B of a device for extracting paste contents shown in FIG. 1;

FIG. 4 is a schematic perspective view illustrating a driving unit for operating a device for extracting paste contents shown in FIG. 1;

FIG. 5 is a schematic exploded perspective view illustrating a device for extracting paste contents according to a second embodiment of the present invention;

FIG. 6 is a sectional view illustrating an internal structure of a second body taken along line B-B of a device for extracting paste contents shown in FIG. 5;

FIG. 7 is a schematic perspective view illustrating a driving unit for operating a device for extracting paste contents shown in FIG. 5;

FIG. 8 is a schematic sectional view illustrating an actuating button used for operating a device for extracting paste contents shown in FIG. 5;

FIG. 9 is a schematic exploded perspective view illustrating a device for extracting paste contents according to a third embodiment of the present invention;

FIG. 10 is a sectional view illustrating an internal structure of a second body taken along line B-B of a device for extracting paste contents shown in FIG. 9;

FIG. 11 is a schematic perspective view illustrating a driving unit for operating a device for extracting paste contents shown in FIG. 9;

FIG. 12 is a schematic exploded perspective view illustrating a device for extracting paste contents according to a fourth embodiment of the present invention;

FIG. 13 is a sectional view illustrating an internal structure of a first body taken along line A-A of a device for extracting paste contents shown in FIG. 12;

FIG. 14 is a view illustrating a coupling structure between first and second bodies of a device for extracting paste contents according to one embodiment of the present invention;

FIG. 15 is a view illustrating a coupling structure between first and second bodies of a device for extracting paste contents according to another embodiment of the present invention;

FIG. 16 is a sectional view illustrating various sectional shapes of a push bar of a device for extracting paste contents according to various embodiments of the present invention;

FIG. 17 is a sectional view illustrating various sectional shapes of a tooth formed in a push bar of a device for extracting paste contents according to various embodiments of the present invention;

FIG. 18 is a perspective view illustrating a device for extracting paste contents according to a seventh embodiment of the present invention;

FIG. 19 is a bottom view of a device for extracting paste contents shown in FIG. 18;

FIG. 20 is an exploded perspective view illustrating a container shown in FIG. 18;

FIG. 21 is a sectional view taken along line C-C of a device for extracting paste contents shown in FIG. 18;

FIG. 22 is a perspective view illustrating a device for extracting paste contents according to an eighth embodiment of the present invention; and

FIG. 23 is a schematic sectional view illustrating a conventional paste container.

### EXPLAIN OF THE DRAWING NUMBER

100, 200, 300, 400, 700: a extracting paste contents
110, 210, 310, 410, 710: a first body
120, 220, 320, 420, 720: a second body
111, 211, 311, 411: a merging portion
112, 212, 312, 412, 712: a cap coupling section
130, 230, 330, 430, 730: a cap
113, 213, 313, 413, 777: a second exhaust port
131, 231, 331, 431: a third exhaust port
114, 214, 314, 414: a second coupling protrusion
123, 223, 323, 423: a second coupling slot
115, 775: a injection port
116, 416, 716: a storing cavity
117, 717: a first exhaust port
118, 418: a exhaust passage
121, 221, 321; a push-bar insertion hole
122; a rotating wheel mounting hole
124; a rotating shaft insertion hole
132, 232, 332, 432; a plug
140; a rotating wheel
140a; a plurality of protrusions
142, 342; a rotating shaft
150, 250, 350, 750; Push bar
160, 260, 360, 760; a piston
224; a first rotating shaft insertion hole
225; a second rotating shaft insertion hole
240; a actuating button
242; a first rotating shaft
244; a second rotating shaft
246; a driving motor 247; a spring
248a; a first metal plate 248b; a second metal plate
340, 741; a push button 344; a tooth driving section

### BEST MODE FOR CARRYING OUT THE INVENTION

According to another aspect of the present invention, there is provided a device for extracting paste contents, the device comprising: a means for individually storing at least one paste content container therein in order to extract the paste contents to an exterior; and a means for pushing the paste contents stored in the paste content container, the pushing means being detachably coupled with the storing means.

The storing means has a storing cavity for individually storing at least one paste content container therein in order to extract the paste content to an exterior, a second exhaust port is formed at a first end of the storing cavity in order to exhaust the paste content, and a second insertion hole is formed at a second end of the storing cavity for receiving the paste content container therein.

The device for exhausting the paste contents further includes a means for mixing and exhausting the paste contents. The mixing and exhausting means has a third exhaust port in order to simultaneously exhaust the paste contents by mixing the paste contents with each other.

The storing means is formed at an outer peripheral surface thereof with a coupling protrusion and the mixing and exhausting means is formed at an inner peripheral surface thereof with a coupling slot corresponding to the coupling protrusion in such a manner that the storing means is detachably coupled to the mixing and exhausting means.

The mixing and exhausting means includes a plug for sealing the third exhaust port.

The pushing means includes a driving means for generating repulsive force for pushing the paste contents.

In addition, the pushing means includes push bars corresponding to storing cavities and first tooth sections having predetermined lengths are formed lengthwise along the push bars.

The first tooth section formed in the push bar has a trapezoidal sectional shape.

The driving means includes a first rotating shaft, a rotating wheel fixedly installed around the first rotating shaft such that the rotating wheel is rotated when external force is applied thereto, and a plurality of first gears fixedly installed around the first rotating shaft at both sides of the rotating wheel and formed at outer peripheral surfaces thereof with second tooth sections corresponding to the first tooth sections so as to engage with the push bars.

The rotating wheel is formed at an outer peripheral surface thereof with a plurality of anti-sliding protrusions.

The rotating wheel has a diameter larger than the diameter of the gear and a part of the rotating wheel is exposed to the exterior.

In addition, the driving means includes a second rotating shaft, a second gear fixedly installed around the second rotating shaft and formed at an outer peripheral surface thereof with a third tooth section, a plurality of third gears fixedly installed around the second rotating shaft at both sides of the second gear and formed at outer peripheral surfaces thereof with fourth tooth sections corresponding to the first tooth sections of the push bars so as to engage with the push bars, a third rotating shaft spaced apart from the second shaft by a predetermined distance, a fourth gear fixedly installed around the third rotating shaft and formed at an outer peripheral surface thereof with a fifth tooth section corresponding to the third tooth section of the second gear so as to engage with the second gear, a fifth gear formed at an outer peripheral surface thereof with a sixth tooth section corresponding to the fifth tooth section of the fourth gear so as to engage with the fourth gear, and a driving motor having a motor shaft fixedly coupled to a center of the fifth gear.

The rotating direction of the second gear is identical to the rotating direction of the fifth gear.

The driving motor is electrically connected to an actuating button, a part of which is exposed to an exterior in order to allow the driving motor to be operated by means of the actuating button.

The driving means further includes an elastic member installed at a lower portion of the actuating button.

In addition, the driving means includes a fourth rotating shaft, a sixth gear fixedly installed around the fourth rotating shaft and formed at an outer peripheral surface thereof with a seventh tooth section, a plurality of seventh gears fixedly installed around the fourth rotating shaft at both sides of the sixth gear and formed at outer peripheral surfaces thereof with eighth tooth sections corresponding to the first tooth sections of the push bars so as to engage with the push bars, a button body provided at a front end thereof with a tooth driving section engaged with the seventh tooth section of the sixth gear and provided at a rear portion thereof with a push button to which external force is applied such that the button body moves in see-saw action about a predetermined portion thereof adjacent to the tooth driving section, and an elastic member installed below the push button in order to return the button body to an initial position thereof.

The push button is exposed to an exterior so as to allow external force to be applied thereto.

The tooth driving section has a triangular sectional shape.

According to still another aspect of the present invention, there is provided a device for extracting paste contents, the device comprising: a means for storing at least one paste content container having at least one storing cavity therein in order to extract the paste contents to an exterior; and a means for pushing the paste contents stored in the paste content container, the pushing means being detachably coupled with the storing means.

The means includes a first case formed at an inner portion thereof with at least one storing cavity for individually storing the paste content container therein, a first exhaust port is formed at a first end of the first case in order to exhaust the paste contents, and an insertion hole is formed at a second end of the first case for receiving the paste content container therein.

The paste content container is formed at an inner portion thereof with at least one storing cavity for storing the paste contents therein, the storing cavity of the paste content container is formed at both sides thereof with an injection port for injecting the paste contents into the paste content container and a second exhaust port for exhausting the paste contents, and a piston is installed in the storing cavity of the paste content container while closely making contact with an inner peripheral wall of the storing cavity in order to push the paste contents from the injection port of the storing cavity of the paste content container to the second exhaust port.

The pushing means includes a second case connected to the insertion hole of the first case and formed at an inner portion thereof with an installation cavity and a push bar positioned in the installation cavity of the second case in order to push the piston from the injection port to the second exhaust port. The push bar includes a push tip having a predetermined length and closely making contact with the piston, a first tooth section integrally formed with the push tip lengthwise along an upper surface of the push tip, a second tooth section formed at a lower surface of the push tip, and a push bar retrieving tip formed in opposition to the push tip.

The push bar retrieving tip downwardly protrudes from the lower surface of the push bar, and a slot is formed at a bottom surface of the second case in order allow the push bar retrieving tip to move along a moving direction of the push bar.

The pushing means further includes a push bar stopper formed at the bottom surface of the second case, aligned in a same plane with the slot, and positioned adjacent to the slot in a vicinity of the first case in order to prevent a backward movement of the push bar.

The pushing means further includes a pusher installed in an installation hole formed at an upper surface of the second case, the pusher has a push button inserted into the installation hole and provided with a first end fixed to a fixing hinge and a second end slantingly protruding from the upper surface of the second case with a predetermined height, a tooth pusher having a first end coupled to a lower center portion of the push button by means of a movable hinge and a second end engaged with the first tooth section of the push bar in order to move the push bar from the injection port of the paste content container to the second exhaust port when the push button is operated, and a pusher release button installed at a rear portion of the push button in order to separate the tooth pusher from the first tooth section of the push bar.

The tooth pusher is connected to the push button in such a manner that the second end of the tooth pusher, the movable hinge and the fixing hinge form a reverse-V shaped configuration in order to allow the second end of the tooth pusher to push the first tooth section when the push button is pushed, and the first tooth section includes teeth inclined in one direction such that the push bar moves from the injection port of the paste content container to the second exhaust port when the tooth pusher pushes the first tooth section.

The device for exhausting the paste contents further includes a hinge for coupling one end portion of the first case to one end portion of the second case and a coupling/decoupling unit installed in opposition to the hinge in order to couple/decouple the first case to/from the second case.

According to still yet another aspect of the present invention, there is provided a device for extracting paste contents, the device comprising: a means for storing at least one paste content container having at least one storing cavity therein in order to extract the paste contents to an exterior; and a means for pushing the paste contents stored in the paste content container, the pushing means being detachably coupled with the storing means.

The device for exhausting the paste contents further includes a connector coupled to a paste content exhaust section of the storing means in order to exhaust the paste contents to an exterior.

The connector includes a brush unit. The brush unit has a coupling section coupled to the paste content exhaust section of the storing means, a body section connected to the coupling section and formed at an upper surface thereof with a plurality of brushes, and an exhaust tube section formed at one side of the body section and communicated with the paste content exhaust section of the storing means.

The exhaust tube section includes a plurality of exhaust tubes installed on the body section of the brush unit, and a size of the exhaust tubes is gradually increased lengthwise along the body section in order to uniformly exhaust paste contents through the exhaust tubes.

The height of the exhaust tubes is lower than that of the brushes so as to prevent the paste contents from directly making contact with a head skin.

### MODE FOR THE INVENTION

Reference will now be made in detail to the preferred embodiments of the present invention with reference to accompanying drawings.

### FIRST EMBODIMENT

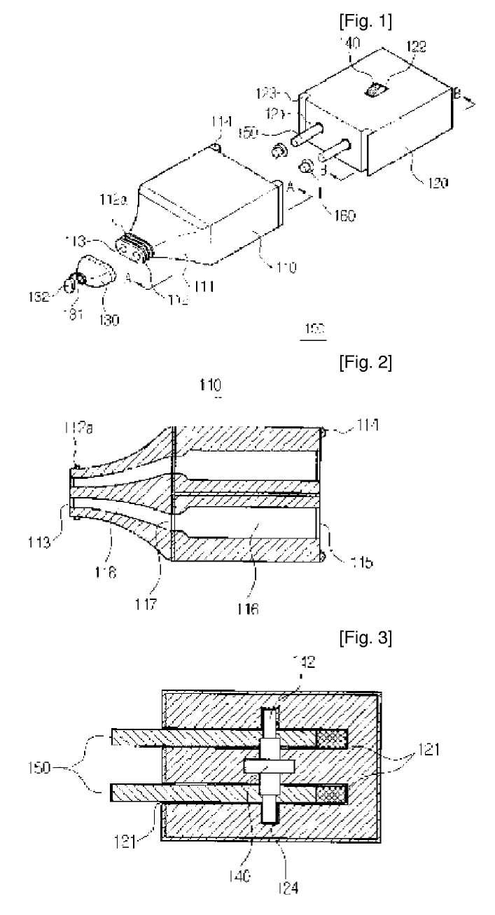

Hereinafter, a device for extracting paste contents according to a first embodiment of the present invention will be described with reference to FIGS. 1 to 4.

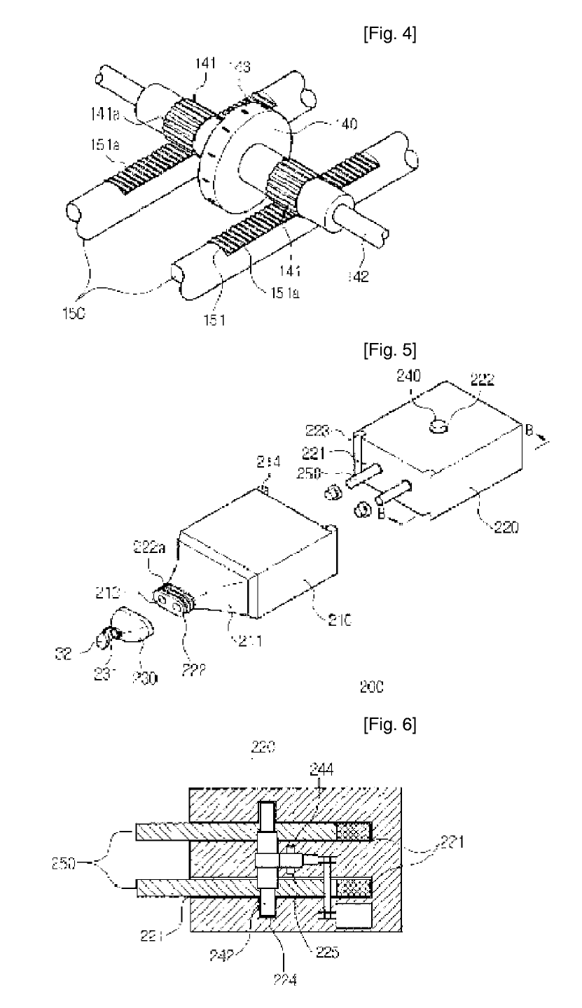

FIG. 1 is a schematic exploded perspective view illustrating a device for extracting paste contents according to the first embodiment of the present invention, FIG. 2 is a sectional view illustrating an internal structure of a first body taken along line A-A of the device for extracting paste contents shown in FIG. 1, FIG. 3 is a sectional view illustrating an internal structure of a second body taken along line B-B of the device for extracting paste contents shown in FIG. 1, and FIG. 4 is a schematic perspective view illustrating a driving unit for operating the device for extracting paste contents shown in FIG. 1.

As shown in FIGS. 1 to 4, the device 100 for extracting the paste contents according to the first embodiment of the present invention includes a first body 110 for storing paste contents to be extracted and a second body 120 detachably coupled to the first body 110 in order to extract the paste contents stored in the first body 110.

The first body 110 is formed with storing cavities 116 for storing two kinds of paste contents. The storing cavities 116 have bottle-like shapes. However, the present invention does not limit the shape and size of the storing cavities 116.

In addition, the first body 110 is formed at one end thereof with injection ports 115 and is formed at the other end thereof with first exhaust ports 117, through which the paste contents are exhausted.

The first body 110 has a merging portion 111 formed at an inner portion thereof with exhaust passages 118 connected to the first exhaust ports 117.

The merging portion 111 is provided at a free end thereof with a cap coupling section 112 having second exhaust ports 113 connected to the exhaust passages 118 in order to exhaust the paste contents, which have passed through the exhaust passages 118.

A cap 130 is detachably coupled to the cap coupling section 112.

The cap 130 has a third exhaust port 131 for exhausting the paste contents to an exterior. In addition, the cap 130 is provided with a plug 132 for sealing the third exhaust port 131.

The cap coupling section 112 is provided at an outer peripheral portion thereof with first coupling protrusions 112a and the cap 130 is formed at an inner portion thereof with first coupling slots (not shown), so that the cap is detachably coupled to the cap coupling section 112.

In addition, the first body 110 is provided with a plurality of coupling protrusions 114 having circular sectional shapes and being formed adjacent to the injection ports 115.

Pistons 160 are inserted into the storing cavities 116 formed in the first body 110 such that the pistons 160 closely make contact with inner peripheral walls of the storing cavities 116.

The paste contents are injected into the storing cavities 116 before the pistons 160 are inserted into the storing cavities 116, so that the pistons 160 push the paste contents towards the first exhaust ports 117 as external force is applied to the pistons 160.

The second body 120 is formed at one side thereof with second coupling slots 123 corresponding to the second coupling protrusions 114 formed in the first body 110. Preferably, the second body 120 has a thickness and a width identical to those of the first body 110. The second body 120 can be formed with various shapes in order to allow a user to easily grip the second body 120.

In addition, the second body 120 is formed at one side thereof with push-bar insertion holes 121 corresponding to the storing cavities 116 of the first body 110. The push-bar insertion holes 121 are formed in the same plane with the second coupling holes 123. The second body 120 is formed at an upper surface thereof with a rotating wheel mounting hole 122 through which a part of a rotating wheel 140 is exposed to the exterior.

In the meantime, a rotating shaft insertion hole 124, into which a rotating shaft 142 of the rotating wheel 140 is inserted, is formed at an inner portion of the second body 120 perpendicularly to the push-bar insertion holes 121.

Push bars 150 are inserted into the push-bar insertion holes 121 of the second body 120 in order to push the pistons 160. According to the present invention, the pistons 160 are separated from the push bars 150. However, it is also possible to integrally form the pistons 160 with the push bars 150.

The push bars 150 have circular sectional shapes. However, the present invention does not limit the shape of the push bars 150.

In addition, each of the push bars 150 has a flat surface 151, which is aligned lengthwise along the push bar 150 and formed with a first tooth section 151a.

The push bars 150 are driven by gears 141 installed around the rotating shaft 142 at both sides of the rotating wheel 140.

The gears 141 are formed at outer peripheral surfaces thereof with second tooth sections 141a corresponding to the first tooth sections 151a formed in the push bars 150.

Preferably, the rotating wheel 140 has a diameter larger than a diameter of the gear 141. In addition, the rotating wheel 140 is formed at an outer peripheral surface thereof with a plurality of protrusions 140a so that the user can easily rotate the rotating wheel 140.

The extracting device 100 having the above construction operates as follows:

First, the user rotates the rotating wheel 140 by using the thumb while gripping the second body 120 with one hand.

At this time, the gears 141 coupled to the rotating shaft of the rotating wheel 140 rotate in the same direction with the rotating wheel 140.

As the gears 141 rotate, the push bars 150 engaged with the gears 141 linearly move in the forward direction.

The push bars 150 may push the pistons 160 inserted into the storing cavities 116 of the first body 110 while moving in the forward direction, so the paste contents are pushed towards the first exhaust ports 117.

As the push bars 150 further move in the forward direction, the paste contents are exhausted to the exterior through the exhaust passages 118, the second exhaust ports 113 and the third exhaust port 131.

### SECOND EMBODIMENT

Hereinafter, a device for extracting paste contents according to a second embodiment of the present invention will be described with reference to FIGS. 5 to 8.

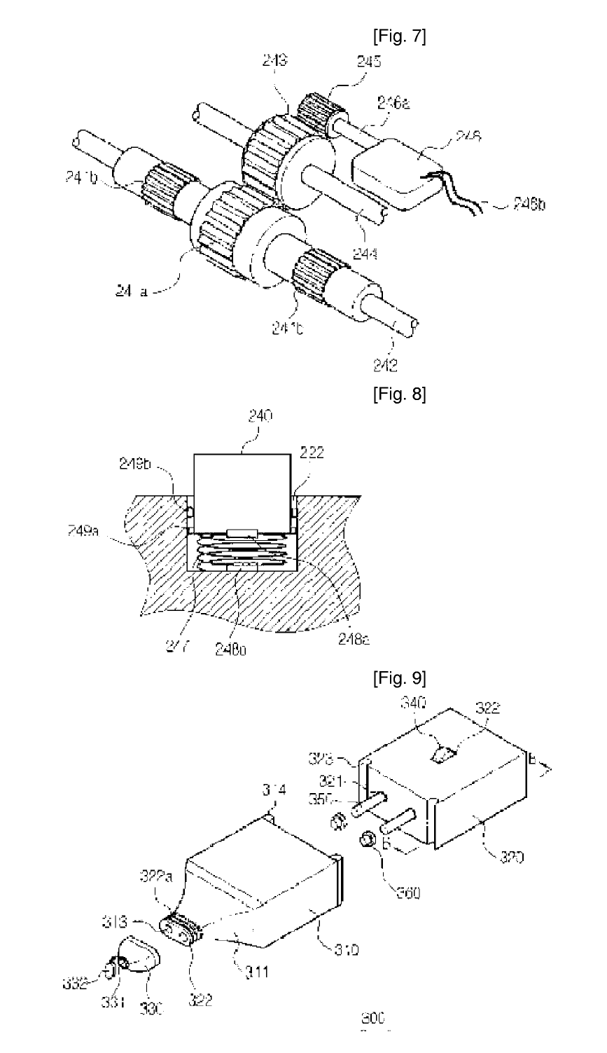

FIG. 5 is a schematic exploded perspective view illustrating a device for extracting paste contents according to a second embodiment of the present invention, FIG. 6 is a sectional view illustrating an internal structure of a second body taken along line B-B of the device for extracting paste contents shown in FIG. 5, FIG. 7 is a schematic perspective view illustrating a driving unit for operating the device for extracting paste contents shown in FIG. 5, and FIG. 8 is a schematic sectional view illustrating an actuating button used for operating the device for extracting paste contents shown in FIG. 5.

As shown in FIGS. 5 to 8, the device 200 for extracting the paste contents according to the second embodiment of the present invention includes a first body 210 for storing paste contents to be extracted and a second body 220 detachably coupled to the first body 210 in order to extract the paste contents stored in the first body 210.

The first body 210 has a structure substantially identical to that of the first body 110 according to the first embodiment. The first body 210 is provided at a front part thereof with a merging portion 211 and is provided at a rear part thereof with second protrusions 214.

In addition, pistons 260 are inserted into storing cavities (not shown) formed in the first body 210 in such a manner that the pistons 260 closely make contact with inner peripheral walls of the storing cavities.

A cap coupling section 222 having second exhaust ports 213 is formed at a front of the merging portion 211. First coupling protrusions 222a are formed at an outer peripheral portion of the cap coupling section 222.

A cap 230 having a third exhaust port 231 is coupled with the cap coupling section 222. First coupling slots (not shown) are formed at an inner peripheral wall of the cap 230 in correspondence with the first coupling protrusions 222a so that the cap 230 is detachably coupled with the cap coupling section 222.

The second body 220 is formed at one side thereof with second coupling slots 223 corresponding to the second coupling protrusions 214 of the first body 210. Preferably, the second body 220 has a thickness and a width identical to those of the first body 210. The second body 220 can be formed with various shapes in order to allow a user to easily grip the second body 220.

The second body 220 is formed at one side thereof with push-bar insertion holes 2 21 corresponding to the storing cavities and is formed at an upper surface thereof with an actuating button mounting hole 222 through which a part of an actuating button 240 is exposed to the exterior.

In addition, a first rotating shaft insertion hole 224, into which a first rotating shaft 242 is inserted, and a second rotating shaft insertion hole 225, into which a second rotating shaft 244 is inserted, are formed at an inner portion of the second body 220 perpendicularly to the push-bar insertion holes 221.

Push bars 250 are inserted into the push-bar insertion holes 221 of the second body 220 in order to push the pistons 260. The push bars 250 are substantially identical to the bush bars 150 of the first embodiment, so the detailed description thereof will be omitted below.

A first gear 241a is coupled around the first rotating shaft 242 and second gears 241b are aligned at both sides of the first gear 241a. The diameters of the second gears 241b are smaller than the diameter of the first gear 241a.

The second gears 241b engage with the push bars 250.

The second shaft 244 is spaced apart from the first rotating shaft 242. In addition, a third gear 243 engaged with the first gear 241a is aligned around the second rotating shaft 244.

The third gear 243 also engages with a fourth gear 245 coupled with a motor shaft 246a of a driving motor 246. The driving motor 246 is electrically coupled with a power source and the actuating button 240 through electric wires 246b, respectively.

According to the present invention, the third gear 243 is interposed between the first gear 241a and the fourth gear 245 in order to rotate the first gear 241a in the same direction with the motor shaft 246a of the driving motor 246. However, it is also possible to directly couple the first gear 241a with the motor shaft 246a.

The actuating button 240 is exposed to the exterior through the actuating button mounting hole 222 formed at the upper surface of the second body 220.

In addition, a first metal plate 248a, which is electrically connected to the power source, is provided at a lower portion of the actuating button 240 and a second metal plate 248b, which is electrically connected to the electric wire 246b, is provided at a bottom surface of the actuating button mounting hole 222.

A spring 247 is interposed between a lower surface of the actuating button 240 and the bottom surface of the actuating button mounting hole 222.

Thus, the driving motor 246 is driven when external force is applied to the actuating button 240, and the operation of the driving motor 246 is stopped if external force applied to the actuating button 240 is released. At this time, the actuating button 240 returns to its initial position by means of bias force of the spring 247.

The actuating button 240 is provided at a lower end thereof with locking protrusions 249a. In addition, locking jaws 249b are formed at an inner peripheral wall of the actuating button mounting hole 222.

Due to the locking protrusions 249a and locking jaws 249b, the actuating button 240 is prevented from being separated from the actuating button mounting hole 222.

The extracting device 200 having the above construction operates as follows:

First, the user pushes the actuating button 240 by using the thumb while gripping the second body 220 with one hand.

At this time, the driving motor 246 electrically connected to the power source and the actuating button 240 is driven.

As the driving motor 246 operates, the fourth gear 245 coupled with the driving motor 246 is rotated. Thus, the third gear 243 engaged with the fourth gear 245 and the first gear 241a engaged with the third gear 243 are also rotated. In addition, the second gears 241b coupled with the first rotating shaft 242 together with the first gear 241a are rotated.

In addition, as the second gears 241b rotate, the push bars 250 engaged with the second gears 241b linearly move in the forward direction.

The push bars 250 may push the pistons 260 inserted into the storing cavities (not shown) of the first body 210 while moving in the forward direction, so the paste contents are extracted to the exterior.

### THIRD EMBODIMENT

Hereinafter, a device for extracting paste contents according to a third embodiment of the present invention will be described with reference to FIGS. 9 to 11.

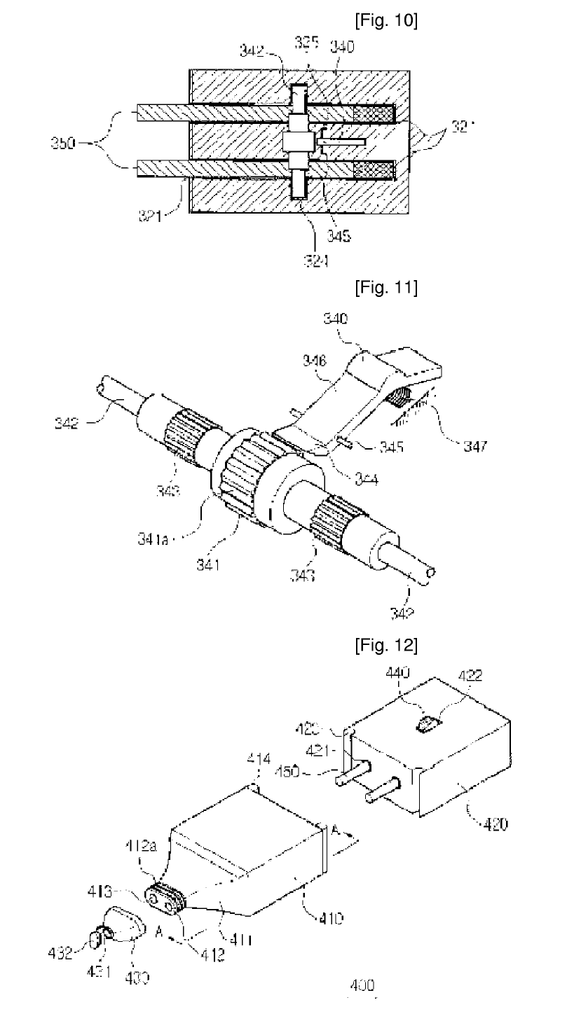

FIG. 9 is a schematic exploded perspective view illustrating the device for extracting paste contents according to a third embodiment of the present invention, FIG. 10 is a sectional view illustrating an internal structure of a second body taken along line B-B of the device for extracting paste contents shown in FIG. 9, and FIG. 11 is a schematic perspective view illustrating the driving unit for operating a device for extracting paste contents shown in FIG. 9.

As shown in FIGS. 9 to 11, the device 300 for extracting the paste contents according to the third embodiment of the present invention includes a first body 310 for storing paste contents to be extracted and a second body 320 detachably coupled to the first body 310 in order to extract the paste contents stored in the first body 310.

The first body 310 has a structure substantially identical to that of the first body 110 according to the first embodiment. The first body 310 is provided at a front part thereof with a merging portion 311 and is provided at a rear part thereof with second protrusions 314.

In addition, pistons 360 are inserted into storing cavities (not shown) formed in the first body 310 in such a manner that the pistons 360 closely make contact with inner peripheral walls of the storing cavities.

A cap coupling section 322 having second exhaust ports 313 is formed at a front of the merging portion 311. First coupling protrusions 322a are formed at an outer peripheral portion of the cap coupling section 322.

A cap 330 having a third exhaust port 331 is coupled with the cap coupling section 322. First coupling slots (not shown) are formed at an inner peripheral wall of the cap 330 in correspondence with the first coupling protrusions 322a so that the cap 330 is detachably coupled with the cap coupling section 322.

The second body 320 is formed at one side thereof with second coupling slots 323 corresponding to the second coupling protrusions 314 of the first body 310. Preferably, the second body 320 has a thickness and a width identical to those of the first body 310. The second body 320 can be formed with various shapes in order to allow a user to easily grip the second body 320.

The second body 320 is formed at one side thereof with push-bar insertion holes 321 and is formed at an upper surface thereof with a push button mounting hole 222 through which a part of a push button 340 is exposed to the exterior.

In addition, a rotating shaft insertion hole 324, into which a rotating shaft 342 is inserted, and a coupling shaft insertion hole 325, into which a coupling shaft 345 is inserted, are formed at an inner portion of the second body 320 perpendicularly to the push-bar insertion holes 321.

Push bars 350 are inserted into the push-bar insertion holes 321 of the second body 320 in order to push the pistons 360. The push bars 350 are substantially identical to the bush bars 150 of the first embodiment, so the detailed description thereof will be omitted below.

A first gear 341 is coupled around the rotating shaft 342 and second gears 343 are aligned at both sides of the first gear 341. The diameters of the second gears 343 are smaller than the diameter of the first gear 341.

The second gears 343 engage with the push bars 350.

The first gear 341 is driven by means of a push button body 346.

The push button body 346 is provided at one end thereof with a tooth driving section 344 for driving the tooth section 341a of the first gear 341.

The present invention does not limit the size of the tooth driving section 344. Preferably, the size of the tooth driving section 344 corresponds to the size of the tooth section 341a formed in the first gear 341.

In addition, an upper portion of the tooth driving section 344 is flat and a lower portion of the tooth driving section 344 is convex. Thus, when the tooth driving section 344 moves up, the tooth driving section 344 engages with the tooth section 341a formed in the first gear 341, thereby rotating the first gear 341. In contrast, when the tooth driving section 344 moves down, the tooth driving section 344 does not engage with the tooth section 341a formed in the first gear 341.

Accordingly, whenever the user pushes the push button 340, the first gear 341 rotates by one pitch and the second gears 343 coupled with the rotating shaft 342 together with the first gear 341 also rotate. As the second gears 343 rotate, the push bars 350 engaged with the second gears 343 may gradually move in the forward direction.

In addition, the coupling shaft 345 is provided in the push button body 346 in adjacent to the tooth driving section 344. The push button body 346 is coupled to the second body 320 by means of the coupling shaft 345 in such a manner that the push button body 346 may move in see-saw action.

The push button 340 is provided in the push button body 346 in opposition to the tooth driving section 344 in such a manner that a part of the push button 340 is exposed to the exterior through the second body 320.

Preferably, the push button 340 has a shape, which can be easily pushed by means of a user s finger, and an anti-sliding member (not shown) can be formed at a surface of the push button 340.

A spring 347 is installed below the push button 340 of the push button body 346. Thus, the push button 340 may return to its initial position by means of bias force of the spring 347 if external force is released from the push button 340.

The extracting device 300 having the above construction operates as follows:

First, the user pushes the push button 340 by using the thumb while gripping the second body 320 with one hand.

As the user pushes the push button 340, the tooth driving section 344 formed in the button body 346 lifts up the tooth section 341 formed in the first gear 341, so that the first gear 341 may rotate.

Thus, the second gears 343 coupled with the rotating shaft 342 are also rotated together with the first gear 341.

As the second gears 343 rotate, the push bars 350 coupled with the second gears 343 linearly move in the forward direction.

The push bars 350 may push the pistons 360 inserted into the storing cavities (not shown) of the first body 310 while moving in the forward direction, so the paste contents are extracted to the exterior.

### FOURTH EMBODIMENT

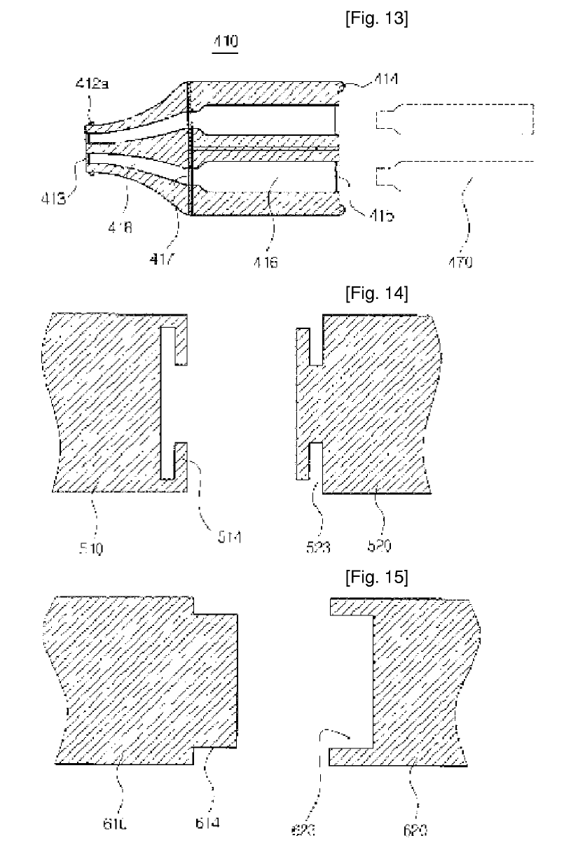

Hereinafter, a device for extracting paste contents according to a fourth embodiment of the present invention will be described with reference to FIGS. 12 and 13.

FIG. 12 is a schematic exploded perspective view illustrating the device for extracting paste contents according to the fourth embodiment of the present invention and FIG. 13 is a sectional view illustrating an internal structure of a first body taken along line A-A of the device for extracting paste contents shown in FIG. 12.

As shown in FIGS. 12 and 13, the device 400 for extracting the paste contents according to the fourth embodiment of the present invention includes a first body 410 having paste content containers 470 for storing paste contents to be extracted and a second body 420 detachably coupled to the first body 410 in order to push pistons (not shown) installed in the paste content containers 470.

The first body 410 is formed with storing cavities 416 for receiving two paste content containers 470 therein. Preferably, the storing cavities 416 have shapes corresponding to the shapes of the paste content containers 470.

In addition, insertion holes 415 are formed at a rear end of the first body 410 in order to allow the paste content containers 470 to be inserted into the storing cavities 416 and first exhaust ports 417 are formed at a front end of the first body 410 in order to exhaust the paste contents stored in the paste content containers 470.

The first body 410 is provided at the front end thereof with a merging portion 411 having exhaust passages 418 connected to the first exhaust ports 417.

The merging portion 411 is provided at a free end thereof with a cap coupling section 412 having second exhaust ports 413 connected to the exhaust passages 418 in order to exhaust the paste contents, which have passed through the exhaust passages 418.

A cap 430 is detachably coupled to the cap coupling section 412. The cap 430 has a third exhaust port 431 for exhausting the paste contents to the exterior. In addition, the cap 430 is provided with a plug 432 for sealing the third exhaust port 431.

The cap coupling section 412 is provided at an outer peripheral portion thereof with first coupling protrusions 412a and the cap 430 is formed at an inner portion thereof with first coupling slots (not shown), so that the cap 430 is detachably coupled to the cap coupling section 412.

In addition, the first body 410 is provided with a plurality of second coupling protrusions 414 having circular sectional shapes and being formed adjacent to the insertion holes 415.

The second body 420 is formed at one side thereof with second coupling slots 423 corresponding to the second coupling protrusions 414 formed in the first body 410. Preferably, the second body 420 has a thickness and a width identical to those of the first body 410. The second body 420 can be formed with various shapes in order to allow the user to easily grip the second body 420.

In addition, the second body 420 is formed at one side thereof with push-bar insertion holes 421 corresponding to the storing cavities 416 of the first body 410. The push-bar insertion holes 421 are formed in the same plane with the second coupling holes 423. The second body 420 is formed at an upper surface thereof with a rotating wheel mounting hole 422 through which a part of a rotating wheel 440 is exposed to the exterior.

The structure of the second body 420 is substantially identical to that of the second body 120 according to the first embodiment of the present invention, which has been described with reference to FIGS. 1 to 4, so it will not be further described below.

### FIFTH EMBODIMENT

A device for extracting paste contents according to the fifth embodiment of the present invention includes a first body substantially identical to the first body of the fourth embodiment, which has been described with reference to FIGS. 12 and 13, and a second body substantially identical to the second body of the second embodiment, which has been described with reference to FIGS. 5 to 8. Thus, the structure and operation thereof will not be further described below.

### SIXTH EMBODIMENT

A device for extracting paste contents according to the sixth embodiment of the present invention includes a first body substantially identical to the first body of the fourth embodiment, which has been described with reference to FIGS. 12 and 13, and a second body substantially identical to the second body of the third embodiment, which has been described with reference to FIGS. 9 to 11. Thus, the structure and operation thereof will not be further described below.

In the above first to sixth embodiments, the first body can be coupled with the second body in various manners. Hereinafter, the coupling structure between the first and second bodies will be described with reference to FIGS. 14 and 15.

FIG. 14 is a view illustrating the coupling structure between first and second bodies of a device for extracting paste contents according to one embodiment of the present invention, and FIG. 15 is a view illustrating the coupling structure between first and second bodies of a device for extracting paste contents according to another embodiment of the present invention.

As shown in FIG. 14, a coupling protrusion 514 having an L-shaped sectional configuration is formed at one end of a first body 510 and a coupling slot 523 corresponding to the coupling protrusion 514 is formed at one end of a second body 520.

Therefore, the first body 510 can be fixedly coupled to the second body 520 by inserting the coupling protrusion 514 into the coupling slot 523.

In addition, as shown in FIG. 15, a coupling protrusion 614 having a rectangular-shaped sectional configuration is formed at one end of a first body 610 and a coupling recess 623 corresponding to the coupling protrusion 614 is formed at one end of a second body 620.

The first body 610 can be fixedly coupled to the second body 620 by inserting the coupling protrusion 614 into the coupling recess 623.

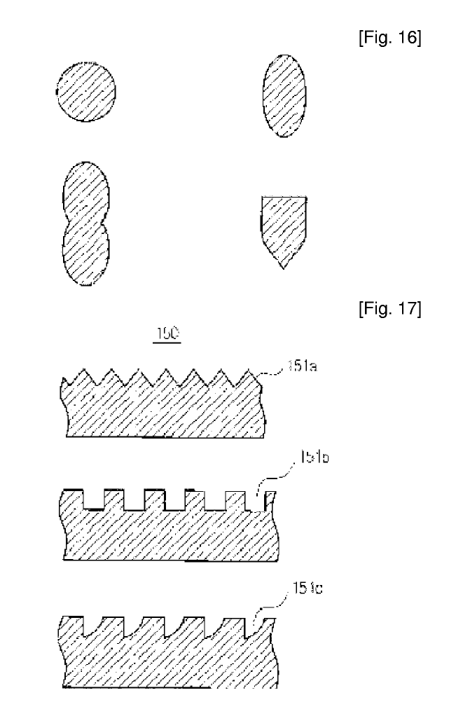

In addition, the push bar described in the above embodiments can be formed with various shapes. FIG. 16 illustrates various sectional shapes of the push bar.

As shown in FIG. 16, the push bar can be formed with a circular sectional shape, an oval sectional shape, a peanut-shell sectional shape, or a reverse pentagonal sectional shape.

In addition, the tooth section described in the above embodiments can be formed with various shapes. FIG. 17 illustrates various sectional shapes of the tooth section.

As shown in FIG. 17, the tooth section can be formed with a trapezoidal sectional shape, a rectangular sectional shape, and a complicated sectional shape in which one sidewall of a tooth has a curved shape and the other sidewall of the tooth has an upright shape.

### SEVENTH EMBODIMENT

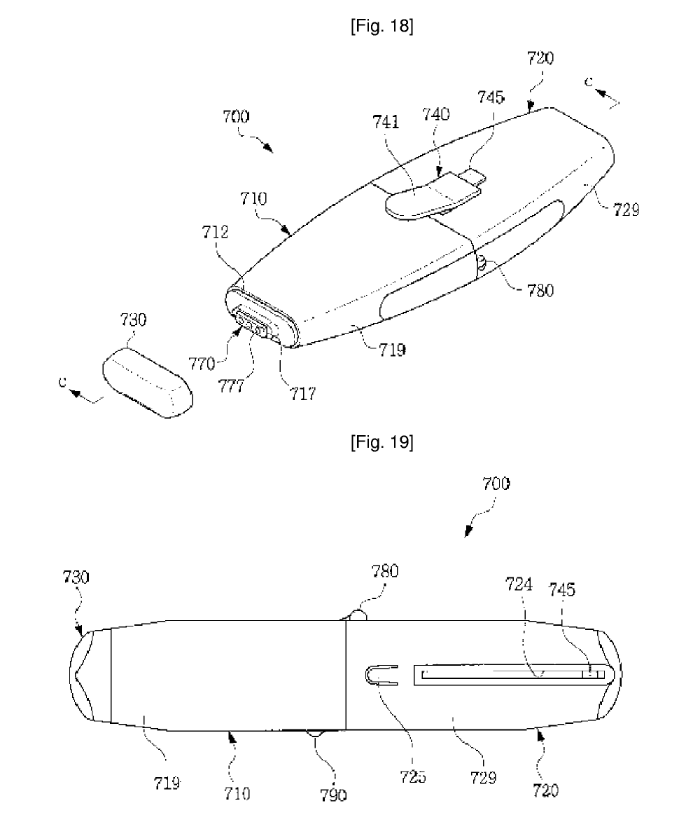

Hereinafter, a device for extracting paste contents according to a seventh embodiment of the present invention will be described with reference to FIGS. 18 and 21.

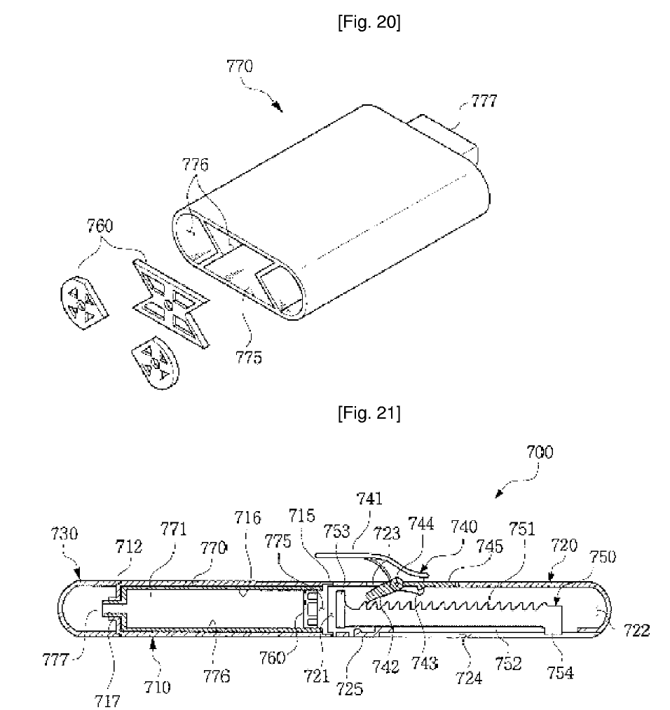

FIG. 18 is a perspective view illustrating the device for extracting paste contents according to the seventh embodiment of the present invention, FIG. 19 is a bottom view of the device for extracting paste contents shown in FIG. 18, FIG. 20 is an exploded perspective view illustrating a container shown in FIG. 18, and FIG. 21 is a sectional view taken along line C-C of the device for extracting paste contents shown in FIG. 18.

As shown in FIGS. 18 to 21, the device 700 for extracting the paste contents according to the seventh embodiment of the present invention includes a first body 710 having a paste content container 770 for storing paste contents 771 to be extracted and a second body 720 detachably coupled to the first body 710 and having a pusher 740 for pushing a piston 760 installed in the paste content container 770.

The first body 710 includes a first case 710 having a storing cavity 716 for accommodating the paste content container 770 therein. The storing cavity 716 has a shape corresponding to an external shape of the paste content container 770.

In addition, the first case 719 is formed at one end thereof, to which the second body 720 is coupled, with an insertion hole 715 for allowing the paste content container 770 to be inserted into the first case 719 and is formed at the other end thereof, which is communicated with the insertion hole 715, with a first exhaust port 717 for exhausting the paste contents 771 stored in the paste content container 770 to the exterior.

A cap coupling section 712 is coupled to an outer portion of the other end of the first case 719. The cap coupling section 712 can be formed with coupling protrusions as described in the first embodiment.

A cap 730 is detachably coupled to the cap coupling section 712.

The paste content container 770 is formed at an inner portion thereof with storing cavities 776 for storing the paste contents 771 therein. An injection port 775 is formed at a front end of the paste content container 770 in order to allow the paste contents 771 to be injected into the paste content container 770 and a second exhaust port 777 is formed at a rear end of the paste content container 770 in order to allow the paste contents 771 to be exhausted to the exterior.

The second exhaust port 777 of the paste content container 770 inserted into the storing cavities 776 of the first case 719 may protrude beyond an end of the first exhaust port 717.

The paste content container 770 includes three storing cavities 776 so that three kinds of paste contents 771 can be stored in the paste content container 770.

The second exhaust port 777 is individually communicated with the storing cavities 776 in such a manner that the paste contents 771 stored in the three storing cavities 776 can be individually exhausted.

Pistons 760 are inserted into the storing cavities 776 while closely making contact with inner peripheral walls of the storing cavities 776 in order to push the paste contents 771 from the injection port 775 of the paste content container 770 to the second exhaust port 777.

The piston 760 is installed in each of the three storing cavities 776.

The piston 760 may move from the injection port 775 to the second exhaust port 777 by means of external force, thereby pushing the paste contents 771 stored in the storing cavities 776 from the injection port 775 of the paste content container 770 to the second exhaust port 777.

The second body 720 includes a second case 729 having an installation cavity 722 for installing the pusher 740 and a push bar 750 therein. Preferably, the second body 720 has a thickness and a width identical to those of the first body 710. In addition, the second body 720 can be formed with various shapes in order to allow the user to easily grip the second body 720.

The installation cavity 722 of the second case 729 has an opening 721 facing the insertion hole 715 of the first case 719.

The push bar 750 is installed in the installation cavity 722 in order to push the piston 760 from the injection port 775 of the paste content container 770 to the second exhaust port 777.

The push bar 750 includes a push tip 753 having a predetermined length and closely making contact with the piston 760, a first tooth section 751 integrally formed with the push tip 753 lengthwise along an upper surface of the push tip 753, a second tooth section 752 formed at a lower surface of the push tip 753, and a push bar retrieving tip 754 formed in opposition to the push tip 753.

The push bar retrieving tip 754 downwardly protrudes from the lower surface of the push bar 750. In order allow the push bar retrieving tip 754 to move along the moving direction of the push bar 750, a slot 724 is formed at the bottom surface of the second case 729. The push bar retrieving tip 754 is exposed to the exterior through the slot 724.

A push bar stopper 725 is formed at the bottom surface of the second case 729.

The push bar stopper 725 is aligned in the same plane with the slot 724 and is adjacent to the slot 724 in the vicinity of the first case 719.

The push bar stopper 725 engages with the second tooth section 752 of the push bar 750 in order to prevent the backward movement of the push bar 750 when the push bar 750 moves from the injection port 775 of the paste content container 770 to the second exhaust port 777.

An installation hole 723 is formed at an upper surface of the second case 729 in order to receive the pusher 740.

The pusher 740 includes a push button 741 inserted into the installation hole 723, a tooth pusher 742, and a pusher release button 745.

The push button 741 inserted into the installation hole 723 has a first end coupled to a fixing hinge 743 and a second end slantingly protruding from the upper surface of the second case 729 with a predetermined height.

Accordingly, the push button 741 protruding from the upper surface of the second case 729 may rotatably move about the fixing hinge 743 in such a manner that a part of the push button 741 can be inserted into the installation hole 723 or protruded therefrom.

The tooth pusher 742 is connected to the push button 741 in order to move the push bar 750 from the injection port 775 of the paste content container 770 to the second exhaust port 777.

One end of the tooth pusher 742 is coupled to a lower center portion of the push button 741 by means of a movable hinge 744 and the other end of the tooth pusher 742 engages with the first tooth section 751 of the push bar 750.

The tooth pusher 742 is connected to the push button 741 in such a manner that the other end of the tooth pusher 742, the movable hinge 744 and the fixing hinge 743 may form a reverse-V shaped configuration in order to allow the other end of the tooth pusher 742 to push the first tooth section 751 when the user pushes the push button 741,

The first tooth section 751 includes teeth inclined in one direction such that the push bar 750 moves from the injection port 775 of the paste content container 770 to the second exhaust port 777 when the tooth pusher 742 pushes the first tooth section 751.

Accordingly, when the user pushes the push button 741, the movable hinge 744 rotatably moves downward about the fixing hinge 743 so that the tooth pusher 742 pushes the first tooth section 751 from the injection port 775 of the paste content container 770 to the second exhaust port 777.

In addition, if pressing force applied to the push button 741 is released, the movable hinge 744 is rotatably moved upwards so that the tooth pusher 742 moves backwards, thereby engaging again with the first tooth section 751. That is, when the tooth pusher 742 moves backwards, the teeth of the tooth pusher 742 do not interrupt the backward movement of the tooth pusher 742 so that the tooth pusher 742 can easily move backwards.

The pusher release button 745 is installed at a rear portion of the push button 741 in order to separate the tooth pusher 742 from the first tooth section 751 of the push bar 750.

The first body 710 is coupled with the second body 720 by means of a hinge 780 installed at one side portion of the device 700 for extracting the paste contents. In addition, a coupling/decoupling unit 790 is installed at the other side portion of the device 700 in opposition to the hinge 780.

Accordingly, the user can separate the first body 710 from the second body 720 about the hinge 780 by operating the coupling/decoupling unit 790. In contrast, when user applies force to the first body 710 or the second body 720 in a state that an end portion of the first body 710 makes contact with an end portion of the second body 720, the first body 710 is coupled with the second body 720 by means of the coupling/decoupling unit 790.

Although a button-type coupling/decoupling unit is described in the seventh embodiment of the present invention, various types of coupling/decoupling units are applicable for the present invention without limitations.

Hereinafter, an operation of the device 700 for extracting the paste contents according to the seventh embodiment of the present invention will be described.

First, in order to install the paste content container 770 having the paste contents 771 in the first body 710, the paste content container 770 is inserted into the storing cavity 716 of the first body 710.

At this time, the push bar 750 is positioned in the installation cavity 722 of the second body 720.

Then, if the user applies force to the first body 710 or the second body 720 in a state that the end portion of the first body 710 makes contact with the end portion of the second body 720, the first body 710 is coupled with the second body 720 by means of the coupling/decoupling unit 790.

In this state, if the user pushes the push button 741 after decoupling the cap 730 from the first body 710, the push bar 750 pushes the piston 760 from the injection port 775 of the paste content container 770 to the second exhaust port 777 so that the paste contents 771 stored in the paste content container 770 are exhausted to the exterior through the second exhaust port 777.

If the paste contents 771 stored in the paste content container 770 inserted into the storing cavity of the first body 710 have been completely used, the paste content container 770 must be exchanged with a new one.

In order to exchange the paste content container 770 with a new paste content container, it is necessary to separate the first body 710 from the second body 720. However, since the push bar 750, which has been moved by means of the tooth pusher 742, is accommodated in the paste content container 770 in the vicinity of the second exhaust port 777, the push bar 750 may be damaged if the first body 710 is separated from the second body 720 under the above state.

Accordingly, it is necessary to return the push bar 750 to its initial position in the second body 720 before the first body 710 is separated from the second body 720.

In order to return the push bar 750 to its initial position in the second body 720, the user pushes the pusher release button 745, thereby separating the tooth pusher 742 engaged with the first tooth section 751 from the push bar 750.

After that, the user moves the push bar retrieving tip 754 in the backward direction along the slot 724 such that the push bar 750 returns to its initial position in the second body 720.

Then, the user separates the first body 710 from the second body 720 about the hinge 780 by operating the coupling/decoupling unit 790 and takes the paste content container 770 out of the first body 710.

In this state, the user inserts the new paste content container into the first body 710 and aligns the end portion of the first body 710 to make contact with the end portion of the second body 720 in such a manner that the first body 710 is coupled with the second body 720 by means of the coupling/decoupling unit 790.

### EIGHTH EMBODIMENT

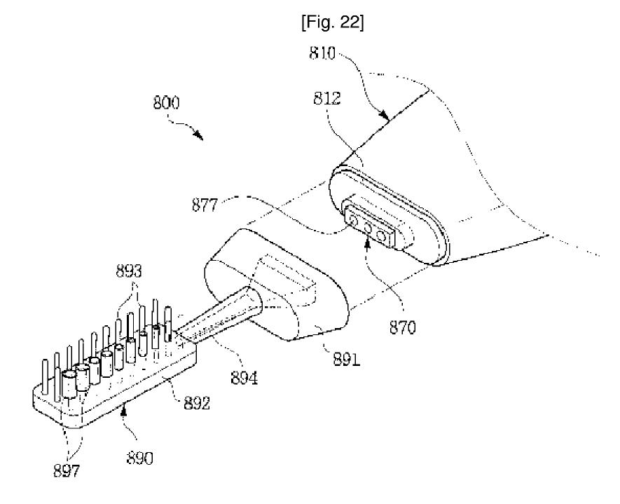

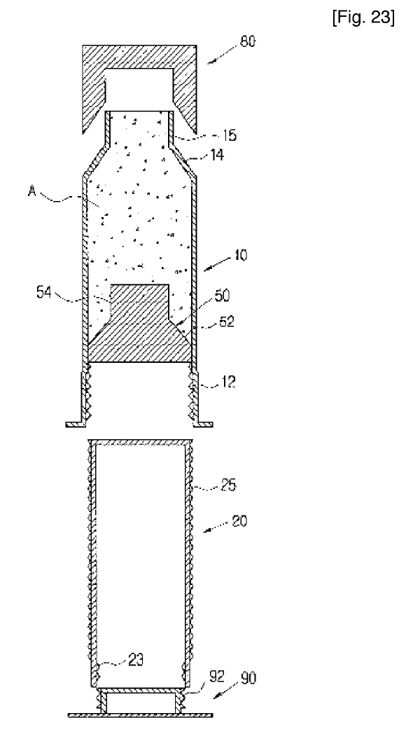

As shown in FIG. 22, it is also possible to couple a brush unit 890 to a paste content exhaust section of the device for extracting the paste contents according to first to seventh embodiments of the present invention. That is, a device 800 for extracting the paste contents includes the brush unit 890 through which the paste contents are exhausted. Herein, the paste contents may include various paste materials, such as a hair-dye and a hair-tonic.

Referring to FIG. 22, the device 800 for extracting the paste contents according to the eighth embodiment of the present invention includes the brush unit 890 coupled with a cap coupling section of a first body 810. The extracting device 800 according to the eighth embodiment of the present invention is substantially identical to the extracting device 700 according to the seventh embodiment of the present invention, except for the brush unit 890 coupled to the cap coupling section 812 of the first body 810, so the following description will be focused on the structure and operation of the brush unit 890.

The brush unit 890 includes a coupling cap 891 coupled to the cap coupling section 812 and a body section 892 connected to the coupling cap 891 and formed at an upper surface thereof with a plurality of brushes 893. A plurality of exhaust tubes 897 are formed between the brushes 893 in order to receive the paste contents through the second exhaust port 877 of the paste content container 870 and exhaust the paste contents to the exterior.

The brush unit 890 has a main exhaust tube 894 installed between the coupling cap 891 and the body section 892 and communicated with the second exhaust port 877 of the paste content container 870. The exhaust tubes 897 are communicated with the main exhaust tube 894.

Preferably, the size of the exhaust tubes 897 is gradually increased lengthwise along the body section 892. That is, since pressure of the paste contents becomes reduced as the paste contents exhausted from the second exhaust port 877 moves towards the free end of the body section 892, the size of the exhaust tubes 897 is gradually increased lengthwise along the body section 892 in order to uniformly exhaust paste contents through the exhaust tubes 897.

Preferably, the height of the exhaust tubes 897 is lower than that of the brushes 893. In this case, if the paste content is the hair-dye, the hair-dye is prevented from directly making contact with a head skin. More preferably, the height of the exhaust tubes 897 is about a half of the height of the brushes 893.

Although it is described in the eighth embodiment of the present invention that the brush unit 890 is coupled to the cap coupling section 812 of the first body, various kinds of connectors capable of using the paste contents can be provided within the scope of the present invention.

In addition, although the eighth embodiment of the present invention discloses the brush unit 890 coupled to the cap coupling section 812 of the first body according to the seventh embodiment of the present invention, the brush unit can be coupled to the cap coupling section of the first body according to the first to sixth embodiments of the present invention.

Furthermore, although the present invention has been described in relation to the connector in the form of the brush unit for hair, various kinds of connectors having various purposes are applicable for the present invention.

### INDUSTRIAL APPLICABILITY

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A device for extracting paste contents, the device comprising:
a means for individually storing at least one paste content therein in order to extract the paste content to an exterior; and
a means for pushing the paste content stored in the storing means, the pushing means being detachably coupled with the storing means.

2. The device as claimed in claim 1, wherein the storing means is formed at an inner portion thereof with at least one storing cavity for individually storing the paste content, a first exhaust port is formed at a first end of the storing cavity in order to exhaust the paste content, a first injection port is formed at a second end of the storing cavity for injecting the paste content into the storing cavity, and the pushing means
includes a pushing member fully making contact with an inner peripheral wall of the storing means having the storing cavity in order to seal the storing means.

3. A device for extracting paste contents, the device comprising:
a storing means having a storing cavity for individually storing at least one paste content container therein in order to extract the paste content to an exterior, a second exhaust port being formed at a first end of the storing cavity in order to exhaust the paste content, a second insertion hole being formed at a second end of the storing cavity for receiving the paste content container therein; and
a pushing means for pushing the paste content stored in the paste content container, the pushing means being detachably coupled with the storing means.

4. The device as claimed in claim 1, further comprising a means for mixing and exhausting the paste contents, wherein the mixing and exhausting means has a third exhaust port in order to simultaneously exhaust the paste contents by mixing the paste contents with each other.

5. The device as claimed in claim 4, wherein the storing means is formed at an outer peripheral surface thereof with a coupling protrusion and the mixing and exhausting means is formed at an inner peripheral surface thereof with a coupling slot corresponding to the coupling protrusion in such a manner that the storing means is detachably coupled to the mixing and exhausting means.

6. The device as claimed in claim 1, wherein the pushing means includes a driving means for generating repulsive force for pushing the paste contents.

7. The device as claimed in claim 6, wherein the pushing means includes push bars corresponding to storing cavities and first tooth sections having predetermined lengths are formed lengthwise along the push bars, respectively.

8. The device as claimed in claim 7, wherein the first tooth section formed in the push bar has a trapezoidal sectional shape.

9. The device as claimed in claim 7, wherein the driving means includes a first rotating shaft, a rotating wheel fixedly installed around the first rotating shaft such that the rotating wheel is rotated when external force is applied thereto, and a plurality of first gears fixedly installed around the first rotating shaft at both sides of the rotating wheel and formed at outer peripheral surfaces thereof with second tooth sections corresponding to the first tooth sections so as to engage with the push bars.

10. The device as claimed in claim 9, wherein the rotating wheel is formed at an outer peripheral surface thereof with a plurality of anti-sliding protrusions.

11. The device as claimed in claim 7, wherein the driving means includes a second rotating shaft, a second gear fixedly installed around the second rotating shaft and formed at an outer peripheral surface thereof with a third tooth section, a plurality of third gears fixedly installed around the second rotating shaft at both sides of the second gear and formed at outer peripheral surfaces thereof with fourth tooth sections corresponding to the first tooth sections of the push bars so as to engage with the push bars, a third rotating shaft spaced apart from the second shaft by a predetermined distance, a fourth gear fixedly installed around the third rotating shaft and formed at an outer peripheral surface thereof with a fifth tooth section corresponding to the third tooth section of the second gear so as to engage with the second gear, a fifth gear formed at an outer peripheral surface thereof with a sixth tooth section corresponding to the fifth tooth section of the fourth gear so as to engage with the fourth gear, and a driving motor having a motor shaft fixedly coupled to a center of the fifth gear.

12. The device as claimed in claim 11, wherein a rotating direction of the second gear is identical to a rotating direction of the fifth gear.

13. The device as claimed in claim 11, wherein the driving motor is electrically connected to an actuating button, a part of which is exposed to an exterior in order to allow the driving motor to be operated by means of the actuating button.

14. The device as claimed in claim 13, wherein the driving means further includes an elastic member installed at a lower portion of the actuating button.

15. The device as claimed in claim 7, wherein the driving means includes a fourth rotating shaft, a sixth gear fixedly installed around the fourth rotating shaft and formed at an outer peripheral surface thereof with a seventh tooth section, a plurality of seventh gears fixedly installed around the fourth rotating shaft at both sides of the sixth gear and formed at outer peripheral surfaces thereof with eighth tooth sections corresponding to the first tooth sections of the push bars so as to engage with the push bars, a button body provided at a front end thereof with a tooth driving section engaged with the seventh tooth section of the sixth gear and provided at a rear portion thereof with a push button to which external force is applied such that the button body moves in see-saw action about a predetermined portion thereof adjacent to the tooth driving section, and an elastic member installed below the push button in order to return the button body to an initial position thereof.

16. The device as claimed in claim 15, wherein the push button is exposed to an exterior so as to allow external force to be applied thereto.

17. The device as claimed in claim 15, wherein the tooth driving section has a triangular sectional shape.

18. A device for extracting paste contents, the device comprising:
a means for storing at least one paste content container having at least one storing cavity therein in order to extract the paste contents to an exterior; and
a means for pushing the paste contents stored in the paste content container, the pushing means being detachably coupled with the storing means.

19. The device as claimed in claim 18, wherein the storing means includes a first case formed at an inner portion thereof with at least one storing cavity for individually storing the paste content container therein, a first exhaust port is formed at a first end of the first case in order to exhaust the paste contents, an insertion hole is formed at a second end of the first case for receiving the paste content container therein, the paste content container is formed at an inner portion thereof with at least one storing cavity for storing the paste contents therein, the storing cavity of the paste content container is formed at both sides thereof with an injection port for injecting the paste contents into the paste content container and a second exhaust port for exhausting the paste contents, and a piston is installed in the storing cavity of the paste content container while closely making contact with an inner peripheral wall of the storing cavity in order to push the paste contents from the injection port of the storing cavity of the paste content container to the second exhaust port.

20. The device as claimed in claim 18, wherein the pushing means includes a second case connected to the insertion hole of the first case and formed at an inner portion thereof with an installation cavity and a push bar positioned in the installation cavity of the second case in order to push the piston from the injection port to the second exhaust port.

21. The device as claimed in claim 20, wherein the push bar includes a push tip having a predetermined length and closely making contact with the piston, a first tooth section integrally formed with the push tip lengthwise along an upper surface of the push tip, a second tooth section formed at a lower surface of the push tip, and a push bar retrieving tip formed in opposition to the push tip.

22. The device as claimed in claim 21, wherein the push bar retrieving tip downwardly protrudes from the lower surface of the push bar, and a slot is formed at a bottom surface of the second case in order allow the push bar retrieving tip to move along a moving direction of the push bar.

23. The device as claimed in claim 22, wherein the pushing means further includes a push bar stopper formed at the bottom surface of the second case, aligned in a same plane with the slot, and positioned adjacent to the slot in a vicinity of the first case in order to prevent a backward movement of the push bar.

24. The device as claimed in claim 20, wherein the pushing means further includes a pusher installed in an installation hole formed at an upper surface of the second case, the pusher has a push button inserted into the installation hole and provided with a first end fixed to a fixing hinge and a second end slantingly protruding from the upper surface of the second case with a predetermined height, a tooth pusher having a first end coupled to a lower center portion of the push button by means of a movable hinge and a second end engaged with the first tooth section of the push bar in order to move the push bar from the injection port of the paste content container to the second exhaust port when the push button is operated, and a pusher release button installed at a rear portion of the push button in order to separate the tooth pusher from the first tooth section of the push bar.

25. The device as claimed in claim 24, wherein the tooth pusher is connected to the push button in such a manner that the second end of the tooth pusher, the movable hinge and the fixing hinge form a reverse-V shaped configuration in order to allow the second end of the tooth pusher to push the first tooth section when the push button is pushed, and the first tooth section includes teeth inclined in one direction such that the push bar moves from the injection port of the paste content container to the second exhaust port when the tooth pusher pushes the first tooth section.

26. The device as claimed in claim 20, further comprising a hinge for coupling one end portion of the first case to one end portion of the second case and a coupling/decoupling unit installed in opposition to the hinge in order to couple/decouple the first case to/from the second case.

27. The device as claimed in claim 1, further comprising a connector coupled to a paste content exhaust section of the storing means in order to exhaust the paste contents to an exterior.

28. The device as claimed in claim 27, wherein the connector includes a brush unit, and the brush unit has a coupling section coupled to the paste content exhaust section of the storing means, a body section connected to the coupling section and formed at an upper surface thereof with a plurality of brushes, and an exhaust tube section formed at one side of the body section and communicated with the paste content exhaust section of the storing means.

29. The device as claimed in claim 28, wherein the exhaust tube section includes a plurality of exhaust tubes installed on the body section of the brush unit, and a size of the exhaust tubes is gradually increased lengthwise along the body section in order to uniformly exhaust paste contents through the exhaust tubes.

30. The device as claimed in claim 28, wherein a height of the exhaust tubes is lower than that of the brushes so as to prevent the paste contents from directly making contact with a head skin.
